(19) United States
(12) Patent Application Publication
(10) Pub. No.: US 2005/0246939 A1
(43) Pub. Date: Nov. 10, 2005

(54) Fish alarm device

(76) Inventor: Jeffrey Keck, Converse, TX (US)

Correspondence Address: Daniel D. Chapman;JACKSON WALKER L.L.P., Suite 2100, 112 E. Pecan Street, San Antonio, TX, 78205, US

(21) Appl. No.: 11/086,043

(22) Filed: Mar. 22, 2005

Related U.S. Application Data
(60) Provisional application No. 60/568,902, filed on May 7, 2004.

(51) Int. Cl. A01K 97/12; A01K 97/10

(52) U.S. Cl. 43/17; 43/21.2

(57) ABSTRACT

A combination of a cylindrical, typically tubular, fishing pole holder and a fish warning device. The fish warning device is a bracket with a pair of depending legs spaced apart sufficiently to enable the legs to straddle the walls of the fishing pole holder. The bracket of the fish warning device also includes a circuit having a biased open switch, a battery and an alarm, the bracket adapted to receive the circuit in the fishing pole, such that the button faces the fishing pole as the fishing pole rests in the tubular, typically cylindrical fishing pole holder.

This application claims priority from provisional patent application Ser. No. 60/568,902, filed on May 7, 2004.

### FIELD OF THE INVENTION

Fish alarm devices. More specifically, a fish alarm device capable of easy removal and transfer from one fishing rod holder to another.

### BACKGROUND OF THE INVENTION

A number of combination fishing rod holders and fishing rod alarm devices are provided for in the prior art whose function it is to hold a fishing rod with the line in the water, in a use position and further to provide a mechanism which, when a fish pulls on the fishing line and in turn on the fishing rod, will set off an alarm to alert the fisherman that he has hooked a fish.

Patents or published applications which disclose fishing rod holders all have built-in fish alarms. These include the following: U.S. Pat. Nos. 4,969,285, 4,399,630, 4,142,316, 3,713,131, 3,646,697, 3,645,028, 3,285,360, 3,064,244, 6,253,483, 5,355,610, 4,972,622, 4,807,384, 4,506,468, 4,455,779, 2002/0162270, and 2002/0112392.

Applicant incorporate herein by reference all of the specifications and drawings set forth in the aforementioned publications.

The aforementioned publications all modify as by drilling or otherwise a standard cylindrical tube fishing rod holder in order to create an integrated tube holder/alarm device.

What is needed is a small, portable, fish alarm device which requires no modification of a standard fishing rod tube holder and no modification of the fishing rod, a fish alarm which is small enough to fit into a tackle box and which requires no tools or modification of the standard fishing pole to engage the same and provide the combined pole holder and fish alarm function in a tube type fishing rod holder.

Applicant provides for a simple fish alarm device as well as a fish alarm device for use in combination with a tube type fishing pole holder, in providing a pole holder mechanism, for example, a U-shaped bracket in combination with a buzzer circuit and/or light circuit and batteries attached thereto, which bracket will slip over the walls of a tube type fishing pole holder and which audible and/or visual alarm device may include Velcro, elastic or other straps to engage the pole and/or tube holder.

Applicant further provides for the foregoing objects in a fish alarm device that contains a U-shaped bracket which has a warning button or momentary switch attached thereto and a warning circuit including a battery and audible and/or visual warning device, which bracket will snugly slip over the walls of a tube shape fishing pole holder in such a manner as to position the warning button towards the fishing pole such that when the tube holder engaged fishing pole is pulled, will assert a pressure against the button and provide an audible and/or visual alert to the fisherman that a fish has been hooked.

### BRIEF DESCRIPTION OF THE DRAWINGS

FIG. 1 is a side elevational view of Applicant's novel fish alarm showing its use in conjunction with a fishing rod and a fishing rod holder.

FIG. 2 is a side elevational view of Applicant's novel fish alarm device.

FIG. 3 is a rear elevational view of Applicant's novel fish alarm device.

FIG. 4 is a rear elevational view of an alternate preferred embodiment of Applicant's novel fish alarm device.

FIG. 5 illustrates a circuit for use with Applicant's buzzer.

### DETAILED DESCRIPTION OF THE PREFERRED EMBODIMENT

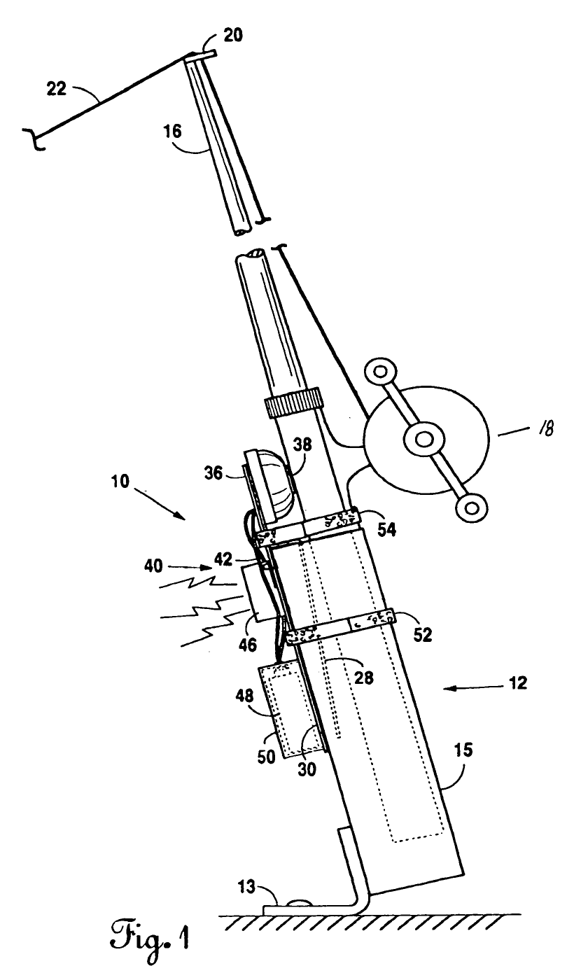

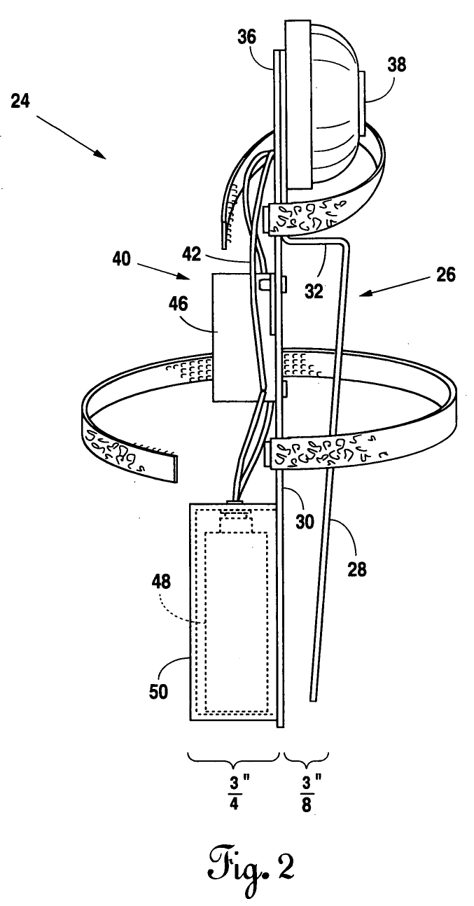

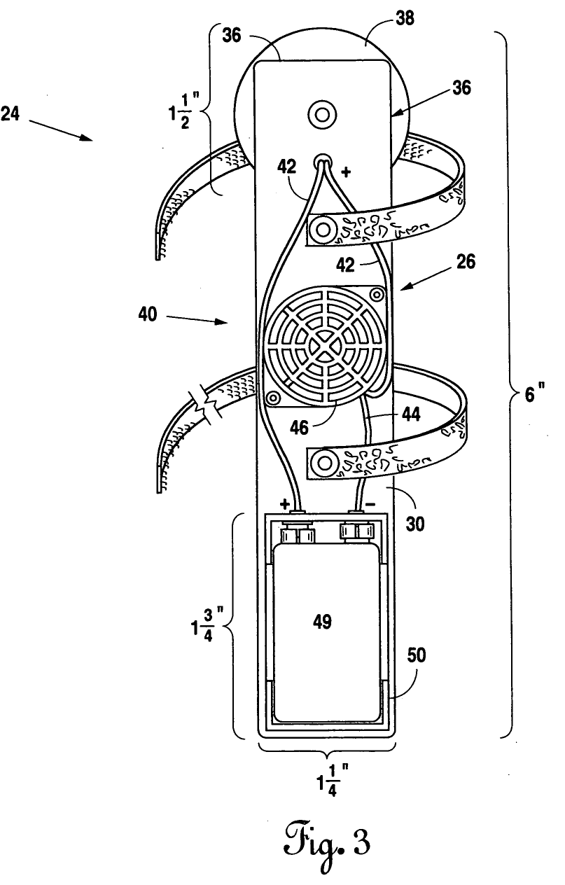

FIGS. 1-3 illustrate Applicant's warning assembly (10) which includes a fishing pole holder (12), typically a cylindrical PVC or metal tube with typically the following dimensional ranges interior diameter: about 2″; length: about 10″; wall thickness: about 0.18″; diameter: about 2⅛″. The standard tube type fishing pole holder is a type known in the prior art and may have an open or close bottom (open bottom illustrated) and may also include a stake (for hammering into the ground, for example) or support surface engagement brackets/means (13) for staking/engaging the fishing pole holder to the ground or other support surface. A fishing pole or rod (16) is provided such as prior art rods with a handle that is dimensioned to fit within the interior diameter of the cylindrical fishing pole holder (12). A reel assembly (18) is provided as part of the fishing pole which may also contain a fishing eye (20), typically at the removed end of the fishing pole and of course, the fishing pole includes is a fishing line (22) such as monofilament.

A warning device (24) is provided that includes a bracket (26) such as a galvanized metal bracket, which has a pair of depending tube engaging legs (28)(30) spaced apart by a spacer (32), the bracket therefore defining, in part, an inverted U-shape which is dimensioned to slide over the walls of the cylindrical tube (12) such that a pushbutton switch (38) (bias to open) or other momentary switch faces the interior of the fishing pole holder (12) and such that the fishing pole may rest against, adjacent or close to the button. Further, bracket (26) includes a mounting plate (36) for mounting the pushbutton switch (38) thereto. The circuit (40) may be mounted on the bracket and includes a pair of leads (42/44) that will engage a buzzer (46) such as one available under the trademark U.S. Electronic Corp, the leads also engaging a battery (48), and the aforementioned button switch (38) operating to control the electricity flow through the circuit. The circuit typically is a simple circuit with the elements engaged in series such that when the switch is depressed, the buzzer will be energized by the battery and emit a sound. The buzzer is powered through a battery (48) such as a 9 volt dry cell battery. Battery (48) may be configured or secured within a battery case (50) on the bracket or with Velcro, or the battery may be placed in a plastic case riveted to the backside of leg (30).

Optionally, lower Velcro or other strap (52) and/or upper Velcro or other strap (54) is provided. The straps may be used to assist in locating the warning device (24) to the fishing pole holder (12) and/or the fishing pole in the manner set forth in FIG. 1. However, the warning device (24) may engage the fishing pole holder simply through the use of bracket (26) as the two depending tube engaging legs (28/30) are spaced apart sufficient to locate the button, which is typically at least ¾″ in diameter facing the interior of the tube and to, typically, frictionally engage the walls of the fishing pole holder. The two legs and the spacer may be made of steel and the two legs may be flexibly biased so their removed ends are close together such that they must be spread apart when engaging the tubeholder and will provide some “grip” to the tubeholder. The tube holder may be located vertically or with the tip pointed towards the water. That is, a device is provided that may easily and without tools be secured to a fishing pole holder with a button located resting against or close to the rod, such that when a fish is hooked and applies torque to the tip of the pole, some part of the fishing rod will depress the button to close the circuit and alert the fisherman.

A fishing tube holder may be provided with rectangular stock, rather than cylindrical, with the bracket engaging the walls of the rectangular stock to position the button adjacent a portion of the pole.

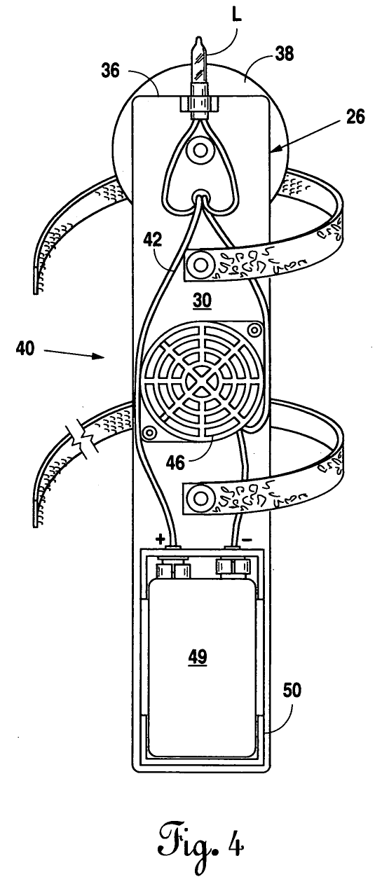

FIG. 4 illustrates an alternate preferred embodiment of Applicant's novel fish alarm device, here showing a lamp L including a bulb wired up with the push button switch (38) such that depression of the button will light the lamp L while simultaneously sounding a buzzer (46) to provide both an audio and a visual alarm to the fisherman. This is especially helpful while fishing at night. In an alternate preferred embodiment Applicant can provide a fishing device that simultaneously provides an audible buzzer and a light L to warn the fisherman of a catch. Thus, the “alarm” of Applicant's device may be a light and/or a buzzer.

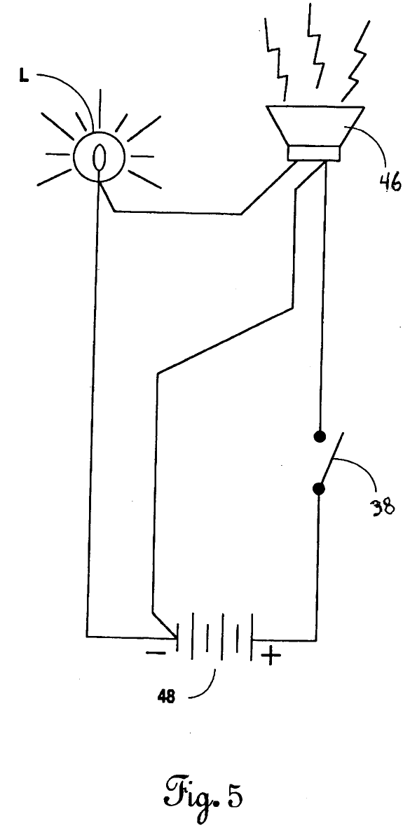

FIG. 5 illustrates a circuit used to power the buzzer (46) of Applicant's alarm, including the wiring to engage switch (38).

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

1. A warning assembly comprising:
a fishing pole holder having inside and outside walls and an interior diameter with an open interior, the interior diameter being sufficient to hold the handle of a fishing pole therein;
a fish warning device including a bracket with a pair depending legs spaced apart sufficiently to enable the legs to engage the fishing pole holder to secure the same to the fishing pole holder, the warning device including a circuit having a bias open switch, a battery and an alarm, the bracket adapted to receive at least part of the circuit thereon and the fishing pole holder such that the button faces the fishing pole.

2. The device of claim 1 wherein the alarm includes a light.

3. The device of claim 1 wherein the alarm includes an audible buzzer.

4. The device of claim 1 wherein the bracket is made of metal or plastic.

5. The device of claim 1 wherein the legs of the bracket have near ends and removed ends and the legs are closer together at the removed ends than at the near ends.

6. The device of claim 1 wherein the fish warning device further includes at least one strap for engaging the fishing pole holder.

7. The device of claim 1 wherein the fish warning device further includes at least one strap for engaging the fishing pole.

8. The device of claim 1 wherein the fish warning device further includes one strap for engaging the fishing pole and another strap for engaging the fishing pole holder.

9. The device of claim 6 wherein the strap is Velcro.

10. The device of claim 7 wherein the strap is Velcro.

11. The device of claim 8 wherein the straps are Velcro.

12. The warning assembly of claim 1 wherein the fishing pole holder is cylindrical.

13. The warning assembly of claim 1 wherein the fishing pole holder is rectangular.

14. A warning device for use with the fishing pole holder, the fishing pole holder having an open interior for receiving a fishing pole therein, the warning device comprising:
a bracket with a pair of depending legs spaced apart sufficiently to enable the legs to engage the fishing pole holder to secure the same to the fishing pole holder;
a circuit having a biased open switch;
a battery in operable engagement with the circuit;
an alarm in operable engagement with the circuit such that it will sound when the switch is closed.

15. The warning device of claim 14 wherein the alarm includes a light.

16. The warning device of claim 14 wherein the alarm includes a buzzer.
